(19) United States
(12) Patent Application Publication
(10) Pub. No.: US 2026/0152834 A1
(43) Pub. Date: Jun. 4, 2026

(54) NON-ORIENTED SILICON STEEL WITH EXCELLENT OVERALL PERFORMANCE AND MANUFACTURING METHOD THEREOF

(71) Applicant: Baoshan Iron & Steel Co., Ltd., Shanghai (CN)

(72) Inventors: Yunwei Hao, Shanghai (CN); Bo Wang, Shanghai (CN); Xianshi Fang, Shanghai (CN)

(21) Appl. No.: 19/122,341

(22) PCT Filed: Aug. 30, 2024
(86) PCT No.: PCT/CN2024/115701

§ 371 Date: Apr. 18, 2025

(30) Foreign Application Priority Data
Sep. 12, 2023 (CN) 202311172846.9

(51) Int. Cl. C22C 38/42; C21D 6/00; C21D 8/1216; C21D 8/1244; C21D 8/1277; C21D 9/46; C22C 38/02; C22C 38/04; C22C 38/06; H01F 1/147

(52) U.S. Cl. CPC C22C 38/42; C21D 6/008; C21D 8/1222; C21D 8/1233; C21D 8/1261; C21D 8/1283; C21D 9/46; C22C 38/02; C22C 38/04; C22C 38/06; H01F 1/14775; C22C 2202/02

(57) ABSTRACT

The present invention discloses a non-oriented silicon steel, in addition to Fe and inevitable impurities, comprising the following chemical elements in percentage by mass: C≤0.0050%, Si: 2.0-4.0%, Mn: 0.1-2.0%, Al: 0.001-2.0%, Cr: 0.001-5.0%, Ni: 0.001%-5.0%, Cu: 0.001-2.0%, wherein the corresponding chemical elements in percentage by mass further satisfy the following: 0<3×Si+0.5×Al+0.5×Mn-5×Cu-2.5×Cr—Ni≤13.5%, wherein each element symbol in the formula represents the percentage by mass of the corresponding element. The present invention further discloses a method of manufacturing the above non-oriented silicon steel. By using the solution of the present invention, a non-oriented silicon steel plate with excellent overall performance in terms of good heat conduction and electromagnetic performance can be obtained.

### TECHNICAL FIELD

The present invention relates to a steel plate and a manufacturing method thereof, in particular to a non-oriented silicon steel plate and a manufacturing method thereof.

### BACKGROUND ART

Non-oriented silicon steel plate is an important metal soft magnetic material for manufacturing motors and electric generators. In recent years, with increasing global demand for energy conservation and environmental protection, new energy automobile industry has developed rapidly, which at the same time promotes development of the non-oriented silicon steel material for drive motors. The operating condition of the drive motor of new energy vehicles is worse than that of conventional motors. For example, the operating temperature of motor is generally 150° C. or higher, and at the same time the drive motor is limited by the internal space layout of the vehicle, and its heat dissipation condition is even worse, so the temperature rise and corresponding cooling of the drive motor during operation is a very important topic in the field of drive motor design. In order to reduce the temperature rise of the drive motor, non-oriented silicon steel requires better heat conduction performance.

In addition, in order to improve operating efficiency and specific power density of the drive motor, motors with higher speed are an important development trend. When the number of pole-pairs of the rotating magnetic field of the motor is constant, motor speed is directly proportional to operating frequency. With the increase of design of motor speed, motor operating frequency will also increase accordingly. Currently, the operating frequency of the drive motor for new energy vehicles has been raised to the intermediate frequency level of 400-2,000 Hz. Compared with conventional motors, the loss of non-oriented silicon steel at intermediate frequency is much greater than the loss of conventional motors at the power frequency of 50 and 60 Hz. In order to reduce iron loss of non-oriented silicon steel, it is necessary to improve electrical resistivity of the non-oriented silicon steel.

Chinese patent document with publication number of CN104726794A and publication date of Jun. 24, 2015, entitled “Non-oriented silicon steel plate and manufacturing method thereof” discloses a non-oriented silicon steel plate, wherein the non-oriented silicon steel plate comprises the following in percentage by weight: Si: 2.0-3.5%, Mn: 0.5-3.5% and Cr: 0.5-3.5%, Al: greater than 0% and 0.8% or less, C: 0.004% or less, S: 0.004% or less, N: 0.004% or less, Ti: 0.004% or less and P: 0.004% or less.

Chinese patent document with publication number of CN104294185A and publication date of Jan. 21, 2015, entitled “Non-oriented silicon steel for high-efficiency motor and manufacturing method thereof” discloses a non-oriented silicon steel for high-efficiency motor. The chemical components in percentage by weight are: C≤0.0030%, Si: 1.9-2.1%, Mn: 0.28-0.32%, Al: 0.10-0.60%, P: 0.01-0.06%, S≤0.0050%, Cu: 0.10-0.30%, Sb: 0.02-0.05% and N≤0.0030%. The solution gives full play to the beneficial effect of each element in physical metallurgy by controlling the total amount of the main alloying elements (Si+Al+Mn) and the amount of auxiliary elements (Cu+P+Sb). It is found that (Cu+P+Sb) elements have composite effect on structure and magnetism of silicon steel, therefore (Cu+P) elements are used to replace part of (Si+Al) elements in the steel, which can improve the number of reverse bending of normalized plate in one hand, and improve the punching performance of the finished plate on the other hand.

It can be seen that in the above patent solution, Si and Al elements are added to the steel as much as possible, so as to significantly improve electrical resistivity of the finished steel plate, thereby further reducing iron loss. However, adding a certain amount of P and Cr elements to steel also reduces the iron loss of the finished steel plate, especially the iron loss at high frequency. In addition, to a certain extent, these measures will limit increase of normalizing temperature of the steel plate and will reduce cold rolling manufacturability.

### SUMMARY OF THE PRESENT INVENTION

One of the purposes of the present invention is to provide a non-oriented silicon steel with excellent overall performance, which controls reasonable thermal conductivity and electrical resistivity of the non-oriented silicon steel by optimizing the chemical composition design and preferably combined with the process design of the steel, so as to obtain a non-oriented silicon steel plate with excellent overall performance in terms of good heat conduction and electromagnetic performance.

In order to achieve the above objective, the present invention provides a non-oriented silicon steel, in addition to Fe and inevitable impurities, the non-oriented silicon steel further comprising the following chemical elements in percentage by mass:
C≤0.0050%, Si: 2.0-4.0%, Mn: 0.1-2.0%, Al: 0.001-2.0%, Cr: 0.001-5.0%, Ni: 0.001-5.0%, Cu: 0.001-2.0%;
wherein the chemical elements in percentage by mass further satisfy the following: 0<3×Si+0.5×Al+0.5×Mn-5×Cu-2.5×Cr—Ni≤13.5%, wherein each element symbol in the formula represents the percentage by mass of the corresponding element.

In the conventional design principle of non-oriented silicon steel products, there is an inherent contradiction between thermal conductivity and electrical resistivity. For example, increase in the content of alloying elements such as Si and Al alone will lead to decrease in thermal conductivity and increase in resistivity of the non-oriented silicon steel. The inventors investigated and found that the difference of the heat conduction of non-oriented silicon steel mainly lies in the strength of metal bonds therein, while the key factor of electrical resistivity of the non-oriented silicon steel is the level of alloying content. Therefore, the present invention optimizes the combination of the types and contents of chemical elements comprised in the non-oriented silicon steel, and at the same time balances the relationship between metal bonds and alloying content. The element synergy feature is defined: 0<3×Si+0.5×Al+0.5×Mn-5×Cu-2.5×Cr—Ni≤13.5%, so as to effectively control the thermal conductivity and electrical resistivity of non-oriented silicon steel and obtain a non-oriented silicon steel having good heat conduction and electromagnetic performance (high thermal conductivity and high electrical resistivity).

Preferably, the present invention further provides a non-oriented silicon steel, the chemical composition of the steel in percentage by mass is:
C≤0.0050%, Si: 2.0-4.0%, Mn: 0.1-2.0%, Al: 0.001-2.0%, Cr: 0.001-5.0%, Ni: 0.001-5.0%, Cu: 0.001-2.0%; with balance being Fe and inevitable impurities.

In the non-oriented silicon steel plate of the present invention, the design principle of the chemical composition is as follows:

C: In the non-oriented silicon steel plate of the present invention, C will greatly hinder the grain growth of the finished non-oriented silicon steel plate, and will easily combine with impurities such as Nb, V, Ti to form fine precipitates, which will lead to increase of loss and generation of magnetic aging. Therefore, it must be strictly controlled to 0.0050% or below. Preferably, the C content in the steel is 0.0005% or more, as a content below 0.0005% will lead to a complex manufacturing process that controls the content in a low range.

Si: In the non-oriented silicon steel plate of the present invention, Si is an effective element to increase electrical resistivity and reduce iron loss. In addition, compared with other solid solution strengthening elements such as Mn, Al and Ni, Si has higher solid solution strengthening ability. Therefore, Si is the most effective element for balancing high strength and low iron loss. If the Si content in the steel is below 2.0%, the above effects cannot be obtained. Therefore, the Si content is set to be 2.0% or more. On the other hand, if the Si content in the steel is too high, the manufacturability, in particular the workability of the non-oriented silicon steel plate will be reduced. In addition, as described below, it is possible to inhibit decrease in workability by appropriately controlling the grain structure of the silicon steel plate. However, if the Si content exceeds 4.0%, the cold workability of the non-oriented silicon steel plate will decrease. Therefore, the present invention controls the Si content in the steel to 4.0% or less. Preferably, the Si content is 3.6% or less.

Mn: In the non-oriented silicon steel plate of the present invention, Mn can improve electrical resistivity: it reacts with the impurity element S to form MnS, which can prevent thermal embrittlement caused by the formation of FeS with low melting point along grain boundaries. Therefore, it is necessary to add 0.1% or more of Mn element. However, if the added amount exceeds 2.0%, grains will not fully grow during final annealing of the steel plate, which will lead to increase of iron loss of the non-oriented silicon steel plate. Therefore, the present invention controls the Mn content to 0.1-2.00%.

Al: In the non-oriented silicon steel plate of the present invention, Al is an element that increases the electrical resistivity and can effectively reduce iron loss of steel. However, when the Al content is higher than 2.0%, the magnetic induction of steel will be significantly reduced, and the cold rolling rollability will be significantly reduced. However, if the Al content is lower than 0.001%, fine nitrides will precipitate in steel, which will hinder grain growth in hot rolled plate annealing and finished product annealing, leading to deterioration of magnetic properties.

Cr: In the non-oriented silicon steel plate of the present invention, Cr can improve thermal conductivity, increase electrical resistivity, reduce eddy current loss and reduce high-frequency iron loss. However, when the Cr content exceeds 5.0%, the magnetic flux density decreases, and the manufacturing cost increases due to the high metal content. If the Cr content is below 0.001%, the cost of the manufacturing process that control the Cr content in a low range will greatly increase. Therefore, the present invention controls the Cr content to 0.001-5.0%.

Ni: In the non-oriented silicon steel plate of the present invention, Ni can improve thermal conductivity, and at the same time perform solid solution strengthening to the silicon steel, facilitating the increase of electrical resistance of the silicon steel to reduce iron loss without reducing saturated magnetic flux density. However, if the Ni content exceeds 5.0%, the manufacturing cost will become significantly higher. If the Ni content is below 0.001%, the cost of the manufacturing process that control the Ni content in a low range will greatly increase. Therefore, the present invention controls the Ni content to 0.001-5.0%.

Cu: In the non-oriented silicon steel plate of the present invention, Cu can increase electrical resistivity and improve thermal conductivity. However, when the Cu content exceeds 2.0%, the magnetic flux density decreases and the production cost increases due to the high metal content. If the Cu content is below 0.001%, the cost of the manufacturing process that control the Ni content in a low range will greatly increase. Therefore, the present invention controls the Cu content to be 0.001-2.0%.

Preferably, the non-oriented silicon steel of the present invention further comprises 0≤Sn≤0.5 wt % and/or 0≤Sb≤0.5 wt %.

In a preferred embodiment of the present invention, the non-oriented silicon steel may further comprise at least one of Sn and Sb elements. Sn and Sb ensure low iron loss of the steel plate by inhibiting oxidation and nitridation during annealing through surface segregation of the steel plate. In addition, the two elements also have the effect of segregation at grain boundaries, thereby improving microstructure and increasing magnetic flux density of the steel plate. However, if the content of Sn and Sb is excessive, the toughness of steel will be reduced, which is possible to render it difficult for cold rolling. Therefore, the content of Sn and Sb should be 0.05% or below respectively.

Unless otherwise specified, the “content” or “amount” of chemical elements in the steel of the present invention refers to mass percentage.

Preferably, the non-oriented silicon steel of the present invention further comprises at least one of the following chemical elements:

$$0 \leq Ca \leq 0.02 wt \% ;$$

$$0 \leq Mg \leq 0.02 wt \% ;$$

$$0 \leq REM \leq 0.02 wt \% .$$

In a preferred embodiment of the present invention, the non-oriented silicon steel may also comprise at least one of Ca, Mg and REM. Ca, Mg and REM are elements that fix impurity S as sulfide or sulfur oxide, inhibit fine precipitation of MnS, and effect to promote recrystallization and grain growth during final annealing. However, when the contents of Ca, Mg and REM are higher than 0.02%, sulfides or sulfur oxides will be excessively generated, which will hinder recrystallization and grain growth during final annealing of the steel plate. Therefore, the present invention controls any one of Ca, Mg and REM to 0.02% or below.

Preferably, the inevitable impurities in the non-oriented silicon steel of the present invention satisfy at least one of the following in percentage by mass: P<0.20%, S≤0.005%, N≤0.005%, Nb≤0.005%, V≤0.005%, Ti≤0.005%.

In the present invention, P, S, N, Nb, V, and Ti are all impurity elements. If the process condition permits, the content is expected to be as low as possible, Among them,

P will accumulate along grain boundaries. Brittleness of silicon steel plate will be increased when the content exceeds 0.20%. Therefore, in some preferred embodiments of the present invention, the P content is controlled to 0.20% or below.

S is an element that is harmful to magnetism of silicon steel. When the S content exceeds 0.005%, the number of harmful inclusions such as MnS and Cu₂S will be greatly increased, which will greatly hinder grain growth and worsen magnetism of steel. Therefore, in some preferred embodiments of the present invention, the S content is controlled to be 0.005% or less.

When the N content exceeds 0.005%, precipitates of N such as Nb, V, Ti and Al will be greatly increased, which will greatly hinder grain growth and worsen magnetism of steel. Therefore, in some preferred embodiments of the present invention, the N content is controlled to be 0.005% or less.

Nb, V and Ti may combine with carbon or nitrogen to form precipitates (carbides or nitrides). These precipitates will worsen magnetic properties of the steel plate. Specifically, these precipitates hinder grain growth during annealing, and worsen magnetic properties. Therefore, in some preferred embodiments of the present invention, the contents of Nb, V and Ti are controlled to 0.005% or less.

Preferably, the chemical composition of the non-oriented silicon steel of the present invention satisfies at least one of the following:

$$Si : 2. - 3.6 \% ;$$

$$Al : 0.55 - 2. \% ;$$

$$Cr : 0.04 - 2.11 \% ;$$

$$Ni : 0.02 - 2.85 \% ;$$

$$Cu : 0.05 - 2. \% .$$

Preferably, in the non-oriented silicon steel of the present invention, the proportion of the grain number with a grain size of 10 μm or more is more than 10%.

More preferably, the proportion of the grain number with a grain size of 10 μm or more is more than 50%.

Preferably, the non-oriented silicon steel of the present invention has a thermal conductivity λ₁₅₀ at 150° C. of 10-35 W/mK and an electrical resistivity ρ at room temperature of 40-90μΩ·cm, and satisfies: 1000≤λ₁₅₀×ρ≤2000. Calculation is done by substituting the dimensionless value. For example, if a non-oriented silicon steel has a thermal conductivity λ₁₅₀ at 150° C. of 20 W/mK and an electrical resistivity ρ at room temperature of 50 μΩ·cm, then λ₁₅₀×ρ=20×50=1000.

In order to better describe the actual operating conditions of the motor, the heat conduction performance of the non-oriented silicon steel of the present invention can be characterized by the thermal conductivity λ₁₅₀ at 150° C. The inventor investigated and found that: the desired temperature rise performance of the permanent-magnet synchronous motor could not be obtained when the range of 1000≤λ₁₅₀×ρ≤2000 is exceeded.

Preferably, the temperature rise of the permanent-magnet synchronous motor manufactured by the non-oriented silicon steel of the present invention is lower than 125° C. during operation.

Preferably, the iron loss of the non-oriented silicon steel of the present invention is P_{10/700}≤50 W/kg.

Another purpose of the present invention is to provide a method of manufacturing a non-oriented silicon steel, which controls the process parameters to adapt to the above composition ratio of the non-oriented silicon steel to obtain a non-oriented silicon steel plate with excellent overall performance in terms of good heat conduction and electromagnetic performance.

In order to achieve the above objective, the present invention provides a method for manufacturing a non-oriented silicon steel comprising the following steps in sequence:
smelting and casting;
hot rolling;
normalizing;
cold rolling;
continuous annealing and applying insulation coating;
wherein the temperature of the continuous annealing is 700-1100° C.

In the present invention, the continuous annealing temperature is controlled at 700˜1100° C. because the annealing temperature needs to be higher than the recrystallization temperature so as to achieve recrystallization of the steel plate structure. On this basis, the lower limit of the continuous annealing temperature is required to be controlled to 700° C. The upper limit of the annealing temperature is not specifically limited. However, considering the overall manufacturing cost, the upper limit of the annealing temperature is 1100° C.

In some preferred embodiments of the present invention, the cold rolling can use a single cold rolling process for directly rolling to the thickness of the finished product of the non-oriented silicon steel.

In another preferred embodiment of the present invention, the cold rolling can use a process of primary cold rolling process, intermediate annealing and secondary cold rolling, wherein the cumulative reduction rate of the second cold rolling is 45-75%.

In this embodiment, the cumulative reduction rate of the secondary cold rolling is controlled to be 45-75% because the reduction rate of the secondary cold rolling has a significant effect on the microstructure of the steel plate. In order to improve microstructure and thereby improving electromagnetic performance, the present invention controls the reduction rate of the second cold rolling to be 45-75%.

The non-oriented silicon steel of the present invention has the following advantages and beneficial effects:

The difference of heat conduction of non-oriented silicon steel mainly depends on the strength of metal bonds in the steel, while the key factor of electrical resistivity of non-oriented silicon steel is the content of alloying elements in the steel. The inventors have found that the relationship between metal bonds and alloying content is balanced in the steel by suitable combinations between the types and contents of chemical elements of the non-oriented silicon steel, thereby effectively controlling the thermal conductivity and electrical resistivity of the non-oriented silicon steel. Further, appropriate manufacturing processes are preferably combined. More preferably, the non-oriented silicon steel is controlled to have a thermal conductivity λ₁₅₀ at 150° C. of 10˜35 W/mK, an electrical resistivity ρ at room temperature of 40-90 μΩ·cm, while satisfying 1000≤λ₁₅₀×ρ≤2000. Finally, the non-oriented silicon steel plate with excellent overall performance in terms of good heat conduction and electromagnetic performance is obtained.

### BRIEF DESCRIPTION OF THE DRAWINGS

FIG. 1 shows the relationship between λ₁₅₀×ρ of the non-oriented silicon steel of the present invention and the temperature rise of the permanent-magnet synchronous motor manufactured by the corresponding non-oriented silicon steel.

FIG. 2 shows the graph of the metallographic structure of the non-oriented silicon steel of Example 5 of the present invention.

### DETAILED DESCRIPTION OF THE EMBODIMENTS

The inventor investigated and found that the difference of heat conduction of non-oriented silicon steel mainly depends on the strength of metal bonds, while the key factor of electrical resistivity of non-oriented silicon steel is the content of alloying content in the steel. Therefore, thermal conductivity and electrical resistivity of the non-oriented silicon steel can be effectively controlled by selecting suitable combinations of types and contents of chemical elements comprised in the non-oriented silicon steel and balancing the relationship between metal bonds and alloying content. In order to better describe the actual operating conditions of the motor, the heat conduction performance of the non-oriented silicon steel can be characterized by the thermal conductivity λ₁₅₀ at 150° C.

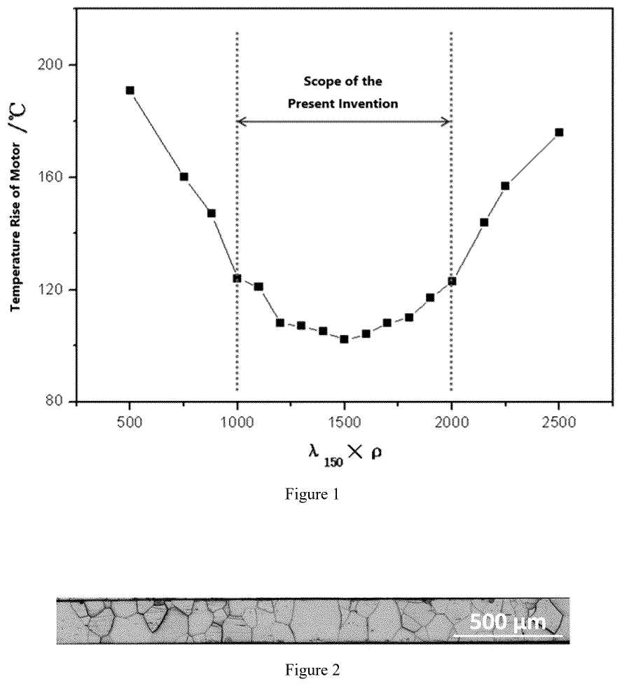

In the present invention, the permanent-magnet synchronous motor was trial-manufactured by steel plates with different thermal conductivity and electrical resistivity. The main parameters of the motor are: outer diameter of 220 mm, stack thickness of 150 mm, rated power of 150 KW and maximum torque of 350 Nm. The temperature rise of the trial-manufactured permanent-magnet synchronous motor was measured, and the relationship between λ₁₅₀×ρ and the temperature rise of the permanent-magnet synchronous motor is shown in FIG. 1.

As can be seen from FIG. 1, when it exceeds the range of 1000≤λ₁₅₀×ρ≤2000, the expected temperature rise performance of the motor cannot be obtained.

The non-oriented silicon steel and manufacturing method thereof described in the present invention will be further explained and illustrated with specific examples and drawings in the specification.

### Examples 1-9 and Comparative Examples 1-6

Tables 1-1 and 1-2 list the amount in percentage by mass of each chemical element in the non-oriented silicon steel plates of Examples 1-9 and the comparative steel plates of Comparative Examples 1-6.

Table 1-1 shows the contents of the main elements and the calculated values of the relationship of corresponding elements in the steel. Table 1-2 shows the contents of the other optional elements and the exemplary inevitable impurities comprised in the steel. The balance of the steel components in each Example and Comparative Example is Fe and inevitable impurities except P, S, N, Nb, V and Ti.

TABLE 1-1
(wt %)

| | | | | | | | | 3 × Si + 0.5 × Al + 0.5 × |
|---|---|---|---|---|---|---|---|---|
| No. | C | Si | Mn | Al | Cr | Ni | Cu | Mn − 5 × Cu − 2.5 × Cr—Ni |
| Example 1 | 0.0023 | 2.01 | 0.32 | 0.88 | 0.06 | 1.13 | 0.23 | 4.2 |
| Example 2 | 0.0025 | 3.97 | 1.58 | 1.89 | 0.04 | 0.02 | 0.05 | 13.3 |
| Example 3 | 0.0045 | 3.41 | 1.97 | 1.97 | 2.08 | 2.85 | 0.001 | 4.1 |
| Example 4 | 0.0032 | 3.66 | 0.11 | 1.82 | 0.22 | 0.09 | 1.96 | 1.5 |
| Example 5 | 0.0018 | 3.22 | 0.42 | 1.15 | 2.11 | 1.19 | 0.02 | 3.9 |
| Example 6 | 0.0027 | 2.55 | 1.77 | 0.55 | 0.001 | 4.95 | 0.14 | 3.2 |
| Example 7 | 0.0026 | 3.99 | 1.98 | 1.96 | 4.97 | 0.001 | 0.05 | 1.3 |
| Example 8 | 0.0022 | 3.32 | 0.29 | 0.0036 | 1.07 | 1.82 | 0.08 | 5.2 |
| Example 9 | 0.0028 | 3.08 | 1.16 | 0.0012 | 0.04 | 0.38 | 0.37 | 7.5 |
| Comparative | 0.0022 | 1.5 | 2.1 | 0.0021 | 5.1 | 0.77 | 2.1 | −18.5 |
| Example 1 | | | | | | | | |
| Comparative | 0.0051 | 4.1 | 0.21 | 0.0037 | 0.31 | 1.22 | 3.1 | −5.1 |
| Example 2 | | | | | | | | |
| Comparative | 0.0018 | 3.52 | 0.05 | 0.0022 | 0.57 | 5.1 | 0.049 | 3.8 |
| Example 3 | | | | | | | | |
| Comparative | 0.0011 | 3.49 | 1.2 | 0.0005 | 0.02 | 1.4 | 2.3 | −1.9 |
| Example 4 | | | | | | | | |
| Comparative | 0.0016 | 3.28 | 0.96 | 0.0011 | 1.06 | 5.2 | 0.032 | 2.3 |
| Example 5 | | | | | | | | |
| Comparative | 0.0024 | 3.32 | 0.18 | 0.0035 | 1.31 | 1.28 | 1.75 | −3.3 |
| Example 6 | | | | | | | | |

TABLE 1-2
(wt %)

| No. | Sn | Sb | Ca | Mg | REM | P | S | N | Nb | V | Ti |
|---|---|---|---|---|---|---|---|---|---|---|---|
| Example 1 | 0.45 | 0.21 | 0.002 | / | / | 0.19 | 0.0047 | 0.0012 | 0.0047 | 0.0037 | 0.0007 |
| Example 2 | / | 0.47 | / | 0.002 | / | 0.01 | 0.0024 | 0.0012 | 0.0011 | 0.0011 | 0.0049 |
| Example 3 | 0.17 | 0.15 | / | / | 0.002 | 0.07 | 0.0022 | 0.0016 | 0.0035 | 0.0024 | 0.0015 |
| Example 4 | 0.05 | 0.19 | 0.018 | 0.018 | / | 0.05 | 0.0011 | 0.0048 | 0.0019 | 0.0013 | 0.0012 |
| Example 5 | / | / | / | / | / | 0.06 | 0.0028 | 0.0011 | 0.0024 | 0.0019 | 0.0019 |
| Example 6 | 0.03 | 0.02 | / | / | 0.017 | 0.04 | 0.0021 | 0.0009 | 0.0021 | 0.0041 | 0.0022 |
| Example 7 | 0.32 | 0.05 | 0.0009 | / | / | 0.02 | 0.0005 | 0.0016 | 0.0011 | 0.0017 | 0.0011 |
| Example 8 | 0.04 | 0.35 | / | 0.0009 | / | 0.06 | 0.0018 | 0.0012 | 0.0022 | 0.0023 | 0.0028 |
| Example 9 | 0.03 | 0.04 | / | / | 0.0008 | 0.04 | 0.0014 | 0.0019 | 0.0029 | 0.0037 | 0.0021 |
| Comparative | 0.004 | 0.02 | / | / | / | 0.03 | 0.0022 | 0.0008 | 0.0051 | 0.0018 | 0.0024 |
| Example 1 | | | | | | | | | | | |
| Comparative | / | / | / | / | / | 0.03 | 0.0011 | 0.0005 | 0.0028 | 0.0051 | 0.0023 |
| Example 2 | | | | | | | | | | | |
| Comparative | 0.002 | 0.003 | / | / | / | 0.04 | 0.0025 | 0.0011 | 0.0021 | 0.0009 | 0.0051 |
| Example 3 | | | | | | | | | | | |
| Comparative | / | 0.005 | / | / | / | 0.07 | 0.0028 | 0.0015 | 0.0005 | 0.0016 | 0.0011 |
| Example 4 | | | | | | | | | | | |
| Comparative | 0.005 | / | / | / | / | 0.02 | 0.0022 | 0.0051 | 0.0018 | 0.0012 | 0.0032 |
| Example 5 | | | | | | | | | | | |
| Comparative | 0.008 | 0.001 | / | / | / | 0.03 | 0.0058 | 0.0008 | 0.0014 | 0.0019 | 0.0018 |
| Example 6 | | | | | | | | | | | |

The non-oriented silicon steel plates in Examples 1-9 of the present invention are all manufactured by the following steps in sequence:

(1) molten iron was obtained from the components shown in Tables 1-1 and 1-2 in blast furnace, then subjected to pre-treatment of molten iron, converter smelting, RH refining and continuous casting in sequence, a continuous casted billet with a nominal thickness of 300 mm was obtained.

(2) heating: the heating temperature was 1050° C., and the holding time was 1.5 hours;

(3) finish rolling and coiling: the final rolling temperature of the steel coil was 800° C., and the coiling temperature was 625° C. A hot-rolled plate with a thickness of 1.5-2.5 mm was obtained;

(4) normalizing annealing: the annealing temperature was 950° C.;

(5) cold rolling after pickling;

(6) continuous annealing and applying insulation coating; wherein the continuous annealing temperature was 700-1100° C.

In each Example, Examples 6-9 and Comparative Examples 4-6 adopted a single cold rolling process; Examples 1-5 adopted process of primary cold rolling+intermediate annealing+secondary cold rolling, wherein the cumulative reduction rate of the secondary cold rolling was controlled to 45-75%. Other steps of Comparative Examples 1-6 are substantially the same as those of the Examples of the present invention. Their differences are listed in the Table.

Table 2 lists the cumulative reduction rates of the secondary cold rolling (not applicable to Examples 6-9 and Comparative Examples 4-6) and the continuous annealing temperatures used in the non-oriented silicon steel plates of Examples 1-9 and Comparative Examples 1-6.

TABLE 2

| | Cumulative | |
|---|---|---|
| | Reduction Rate | Continuous |
| | of the Secondary | Annealing |
| | Cold Rolling | Temperature |
| No. | /% | /° C. |
| Example 1 | 75 | 700 |
| Example 2 | 66 | 1000 |
| Example 3 | 56 | 1050 |
| Example 4 | 45 | 800 |
| Example 5 | 68 | 1050 |
| Example 6 | / | 850 |
| Example 7 | / | 950 |
| Example 8 | / | 1100 |
| Example 9 | / | 980 |
| Comparative Example 1 | 85 | 680 |
| Comparative Example 2 | 81 | 950 |
| Comparative Example 3 | 77 | 1150 |
| Comparative Example 4 | / | 1000 |
| Comparative Example 5 | / | 690 |
| Comparative Example 6 | / | 1150 |

In addition, the non-oriented silicon steel plates of Examples 1-9 and the comparative steel plates of Comparative Examples 1-6 were sampled, and each related performance of the steel plates of the Examples and Comparative Examples were tested. The results obtained by the related performance tests and observation are listed in Table 3. The specific testing methods of related performances are as follows:

Microstructure detection: grain size statistics is tested by the area method of “GB/T6394-2017 Method of Determining Average Grain Size of Metals”.

Iron loss performance test: based on GB/T10129-2019 Method of Measuring Medium Frequency Magnetic Performance of Electrical Steel Strip (Sheet)”, the iron loss performance test was carried out by using the Epstein Square Method. The test was carried out at a constant temperature of 20° C. The sample size was 30 mm×300 mm. The target mass was 0.25 kg. The test parameter was P_{10/700}.

Thermal conductivity test: the test was carried out according to GB/T 32064-2015 by the transient plane heat source method. Hot Disk TPS2500S may be used as the testing device.

Electrical resistivity test at room temperature: measured according to GB/T 351-2019.

Temperature rise test: measured according to GB/T 18488.2-2015 Drive Motor Systems for Electric Vehicles—Part 2: Test Methods

Table 3 lists the non-oriented silicon steel plates of Examples 1-9 and comparative steel plates of Comparative Examples 1-6, and the results of the related performance tests of the permanent-magnet synchronous motors manufactured from the steel plates.

TABLE 3

| | | Ratio of the | | | | | |
|---|---|---|---|---|---|---|---|
| | | Grain | | | | | |
| | | Number | | | | | |
| | | with a | | | | | |
| | Thickness | Grain Size | | Thermal | Electrical | | |
| | of Finished | of 10 μm or | Iron Loss | Conductivity | Resistivity | | Temperature |
| | Product | More | P_{10/700} | λ₁₅₀ | ρ | | Rise |
| No. | mm | % | (W/kg) | (W/mK) | (μΩ · cm) | λ₁₅₀ × ρ | 0° C. |
| Example 1 | 0.25 | 15 | 28 | 28 | 68 | 1904 | 122 |
| Example 2 | 0.30 | 90 | 30 | 22 | 76 | 1674 | 118 |
| Example 3 | 0.27 | 100 | 20 | 12 | 85 | 1020 | 120 |
| Example 4 | 0.50 | 50 | 49 | 34 | 42 | 1428 | 105 |
| Example 5 | 0.20 | 95 | 23 | 17 | 79 | 1343 | 108 |
| Example 6 | 0.15 | 60 | 19 | 20 | 55 | 1098 | 118 |
| Example 7 | 0.18 | 80 | 21 | 17 | 78 | 1326 | 109 |
| Example 8 | 0.35 | 100 | 40 | 20 | 57 | 1135 | 115 |
| Example 9 | 0.10 | 90 | 11 | 20 | 53 | 1059 | 120 |
| Comparative | 0.25 | 2 | 29 | 9 | 91 | 819 | 160 |
| Example 1 | | | | | | | |
| Comparative | 0.27 | 9 | 33 | 36 | 60 | 2142 | 157 |
| Example 2 | | | | | | | |
| Comparative | 0.18 | 100 | 20 | 37 | 54 | 2001 | 141 |
| Example 3 | | | | | | | |
| Comparative | 0.20 | 80 | 25 | 25 | 91 | 2275 | 168 |
| Example 4 | | | | | | | |
| Comparative | 0.30 | 5 | 51 | 16 | 60 | 967 | 142 |
| Example 5 | | | | | | | |
| Comparative | 0.35 | 100 | 55 | 16 | 58 | 922 | 154 |
| Example 6 | | | | | | | |

Note:
The “Temperature Rise” in Table 3 refers to the temperature rise data of the permanent-magnet synchronous motor trial-manufactured by corresponding steel plates of Examples and Comparative Examples.

FIG. 2 shows the graph of metallographic structure of the non-oriented silicon steel of Example 5 of the present invention. As shown in FIG. 2, the proportion of the grain number with a grain size of 10 μm or more exceeds 50%.

It can be seen by combining Table 1, Table 2 and Table 3 that in Examples 1-9 which conform to the design requirements of the present invention, due to the unique composition design and optimized process design of the present invention, the finally obtained finished product of the non-oriented silicon steel plate has a thermal conductivity λ₁₅₀ at 150° C. of 10-35 w/mK, and an electrical resistivity ρ at room temperature of 40-90 μΩ·cm, and satisfies: 1000≤λ₁₅₀×ρ≤2000, while good electromagnetic performance is obtained, and the iron loss of the finished steel plate P_{10/700} is ≤50 W/kg. The permanent-magnet synchronous motors manufactured by the non-oriented silicon steel of these Examples all have temperature rise lower than the target value of 125° C.

However, the thermal conductivity and electrical resistivity of the comparative steel plates of Comparative Examples 1-6 fail to meet the requirements of the present invention due to at least one of their composition, the double cold rolling process and the continuous annealing process is not satisfied. In particular, the permanent-magnet synchronous motors manufactured by the steel plates of these Comparative Examples all have temperature rise higher than the target value of 125° C. This is because of the presence of heat emission and heat dissipation when the motor is in operation. The condition of heat emission is closely related to the electrical resistivity of the silicon steel sheet, while the condition of heat dissipation is related to the thermal conductivity of the silicon steel sheet. When these two performances of the silicon steel sheet cannot satisfy the requirements, the heat emitted by the silicon steel sheet cannot be conducted away in time, which leads to temperature rise of the motor. If the temperature rise is too high, it will severely affect the performances and operation safety of the motor and must be controlled within a suitable range.

It should be noted that the means of combination of each technical feature in the present application is not limited to the means of combination described in the claims of the present application or the means of combination described in the specific embodiments of the present application. All technical features described in the present application can be freely combined in any way unless contradicts with each other.

It should also be noted that the examples listed above are only specific embodiments of the present invention. Obviously, the present invention is not limited to the above examples, and those similar changes or modifications that can be directly derived or readily associated by those skilled in the art from the disclosure of the present invention, shall all belong to the protection scope of the present invention.

1. A non-oriented silicon steel, in addition to Fe and inevitable impurities, comprising the following chemical elements in percentage by mass:
C≤0.0050%, Si: 2.0-4.0%, Mn: 0.1-2.0%, Al: 0.001-2.0%, Cr: 0.001-5.0%, Ni: 0.001-5.0%, Cu: 0.001-2.0%;
wherein the chemical elements in percentage by mass further satisfy the following: 0<3×Si+0.5×Al+0.5×Mn-5×Cu-2.5×Cr—Ni≤13.5%, wherein each element symbol in the formula represents the percentage by mass of the corresponding element.

2. The non-oriented silicon steel according to claim 1, characterized in that, the chemical composition of the non-oriented silicon steel in percentage by mass is:
C≤0.0050%, Si: 2.0-4.0%, Mn: 0.1-2.0%, Al: 0.001-2.0%, Cr: 0.001-5.0%, Ni: 0.001-5.0%, Cu: 0.001-2.0%; with balance being Fe and inevitable impurities.

3. The non-oriented silicon steel according to claim 1, characterized in that, the non-oriented silicon steel further comprises 0≤Sn≤0.5 wt % and/or 0≤Sb≤0.5 wt %.

4. The non-oriented silicon steel according to claim 1, characterized in that, the non-oriented silicon steel further comprises at least one of the following chemical elements:
$$0 \leq Ca \leq 0.02 wt \% ;$$
$$0 \leq Mg \leq 0.02 wt \% ;$$
$$0 \leq REM \leq 0.02 wt \% .$$

5. The non-oriented silicon steel according to claim 1, characterized in that, the inevitable impurities of the non-oriented silicon steel satisfy at least one of the following in percentage by mass: P≤0.2%, S≤0.005%, N≤0.005%, Nb≤0.005%, V≤0.005%, Ti≤0.005%.

6. The non-oriented silicon steel according to claim 1, characterized in that, the chemical composition of the non-oriented silicon steel satisfies at least one of the following in percentage by mass:
$$Si : 2. - 3.6 \% ;$$
$$Al : 0.55 - 2. \% ;$$
$$Cr : 0.04 - 2.11 \% ;$$
$$Ni : 0.02 - 2.85 \% ;$$
$$Cu : 0.05 - 2. \% .$$

7. The non-oriented silicon steel according to claim 1, characterized in that, the proportion of the grain number with a grain size of 10 μm or more in the non-oriented silicon steel is more than 10%.

8. The non-oriented silicon steel according to claim 7, characterized in that, the proportion of the grain number with a grain size of 10 μm or more in the non-oriented silicon steel is more than 50%.

9. The non-oriented silicon steel according to claim 1, characterized in that, the non-oriented silicon steel has a thermal conductivity λ₁₅₀ at 150° C. of 10-35 W/mK and an electrical resistivity ρ at room temperature of 40-90 μΩ·cm, and satisfies the following: 1000≤λ₁₅₀×ρ≤2000.

10. The non-oriented silicon steel according to claim 1, characterized in that, the iron loss of the non-oriented silicon steel satisfies: P_{10/700}≤50 W/kg.

11. A permanent-magnet synchronous motor manufactured by the non-oriented silicon steel according to claim 1, characterized in that, the temperature rise of the permanent magnet synchronous motor is lower than 125° C. during operation.

12. A method for manufacturing the non-oriented silicon steel according to claim 1, characterized in that, the method comprises the following steps in sequence:
smelting and casting;
hot rolling;
normalizing;
cold rolling;
continuous annealing and applying insulation coating;
wherein the temperature of the continuous annealing is 700-1100° C.

13. The method according to claim 12, characterized in that, in the cold rolling step, a single cold rolling process is used.

14. The method according to claim 12, characterized in that, in the cold rolling step, a process of primary cold rolling, intermediate annealing and secondary cold rolling is used, wherein the cumulative reduction rate of the secondary cold rolling is 45-75%.

15. The non-oriented silicon steel according to claim 2, characterized in that, the non-oriented silicon steel further comprises 0≤Sn≤0.5 wt % and/or 0≤Sb≤0.5 wt %.

16. The non-oriented silicon steel according to claim 2, characterized in that, the non-oriented silicon steel further comprises at least one of the following chemical elements:
$$0 \leq Ca \leq 0.02 wt \% ;$$
$$0 \leq Mg \leq 0.02 wt \% ;$$
$$0 \leq REM \leq 0.02 wt \% .$$

17. The non-oriented silicon steel according to claim 2, characterized in that, the inevitable impurities of the non-oriented silicon steel satisfy at least one of the following in percentage by mass: P<0.2%, S≤0.005%, N≤0.005%, Nb≤0.005%, V≤0.005%, Ti≤0.005%.

18. The non-oriented silicon steel according to claim 2, characterized in that, the chemical composition of the non-oriented silicon steel satisfies at least one of the following in percentage by mass:
$$Si : 2. - 3.6 \% ;$$
$$Al : 0.55 - 2. \% ;$$
$$Cr : 0.04 - 2.11 \% ;$$
$$Ni : 0.02 - 2.85 \% ;$$
$$Cu : 0.05 - 2. \% .$$

19. The non-oriented silicon steel according to claim 2, characterized in that, the proportion of the grain number with a grain size of 10 μm or more in the non-oriented silicon steel is more than 10%.

20. The non-oriented silicon steel according to claim 19, characterized in that, the proportion of the grain number with a grain size of 10 μm or more in the non-oriented silicon steel is more than 50%.
